(19) United States
(12) Patent Application Publication
(10) Pub. No.: US 2016/0295118 A1
(43) Pub. Date: Oct. 6, 2016

(54) METHOD AND APPARATUS FOR DISPLAYING FRAMING INFORMATION

(71) Applicant: Xiaomi Inc., Beijing (CN)

(72) Inventors: Mingyong TANG, Beijing (CN); Huayijun LIU, Beijing (CN); Tao CHEN, Beijing (CN)

(73) Assignee: Xiaomi Inc.

(21) Appl. No.: 14/955,313

(22) Filed: Dec. 1, 2015

Related U.S. Application Data
(63) Continuation of application No. PCT/CN2015/088686, filed on Aug. 31, 2015.

(30) Foreign Application Priority Data
Mar. 31, 2015 (CN) 201510150277.7

(51) Int. Cl. H04N 5/232; G02B 27/01; H04N 5/775; H04N 9/31; G06K 9/62

(52) U.S. Cl. CPC H04N 5/23293; H04N 9/31; G06K 9/6215; H04N 5/775; G02B 27/0172; G02B 2027/0178; G02B 2027/014; G02B 2027/0141

(57) ABSTRACT

The present disclosure refers to a method and an apparatus for displaying framing information of a photographic apparatus on a displaying apparatus, such as smart glasses. The method includes determining framing information of the photographic apparatus; and displaying the framing information on the displaying apparatus.

### CROSS-REFERENCE TO RELATED APPLICATIONS

This application is a continuation application of International Application No. PCT/CN2015/088686, filed on Aug. 31, 2015, which is based upon and claims priority to Chinese Patent Application No. 201510150277.7, filed on Mar. 31, 2015, the entire contents of all of which are incorporated herein by reference.

### TECHNICAL FIELD

The present disclosure relates to electronic technology and, more particularly, to a method and an apparatus for displaying framing information.

### BACKGROUND

With the development of science and technology, more and more smart wearable apparatus have entered normal users' lives. The smart wearable apparatus may not only facilitate the users' lives, but also better coordinate the present electronic products. Take smart glasses for example. In the related art, by displaying the images currently collected by a digital camera on the smart glasses, the user may view the images currently collected by the digital camera via the smart glasses instead of via the display screen of the digital camera, thus reducing the power consumption of the digital camera. However, when there is a need to adjust the current framing range of the digital camera, the user still needs to take off the smart glasses and adjust the photographing direction of the digital camera by viewing the frame displayed on the display screen of the digital camera. Therefore, the operation for adjusting the framing range of the digital camera is relatively cumbersome for the user.

### SUMMARY

According to a first aspect of embodiments of the present disclosure, a method for displaying framing information is provided. The method includes: determining the framing information of a photographic apparatus; and displaying the framing information on the displaying apparatus.

According to a second aspect of embodiments of the present disclosure, an apparatus for displaying framing information is provided. The apparatus includes a processer and a memory for storing instructions executable by the processor. The processer is configured to: determine the framing information of a photographic apparatus; and display the framing information on a displaying apparatus.

According to a third aspect of embodiments of the present disclosure, a non-transitory computer-readable storage medium is provided. The non-transitory computer-readable storage medium has stored therein instructions that, when executed by a processor of a device, cause the device to perform a method for displaying framing information. The method includes: determining the framing information of a photographic apparatus; and displaying the framing information on a displaying apparatus.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a flow chart showing a method for displaying framing information according to an exemplary embodiment.

FIG. 1B is a schematic diagram of an applicable scene according to an embodiment of the present disclosure.

FIG. 2 is a flow chart showing a method for displaying framing information according to a first exemplary embodiment.

FIG. 3A is a schematic diagram of a system formed by smart glasses and a photographic apparatus and applicable to embodiments of the present disclosure.

FIG. 3B is a schematic diagram of a framing view corresponding to framing information of the photographic apparatus of FIG. 3A according to an exemplary embodiment of the present disclosure.

FIG. 3C is a first schematic diagram of an image view taken by the smart glasses of FIG. 3A according to an exemplary embodiment of the present disclosure.

FIG. 3D is a second schematic diagram of an image view taken by the smart glasses of FIG. 3A according to an exemplary embodiment of the present disclosure.

FIG. 3E is a third schematic diagram of an image view taken by the smart glasses of FIG. 3A according to an exemplary embodiment of the present disclosure.

FIG. 4 is a flow chart showing a method for displaying framing information, according to a second exemplary embodiment.

FIG. 5 is a flow chart showing a method for displaying framing information, according to a third exemplary embodiment.

FIG. 6 is a block diagram of an apparatus for displaying framing information according to an exemplary embodiment.

FIG. 7 is a block diagram of another apparatus for displaying framing information according to an exemplary embodiment.

FIG. 8 is a block diagram of yet another apparatus for displaying framing information according to an exemplary embodiment.

FIG. 9 is a block diagram of a device for displaying framing information according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatus and methods consistent with aspects related to the invention as recited in the appended claims.

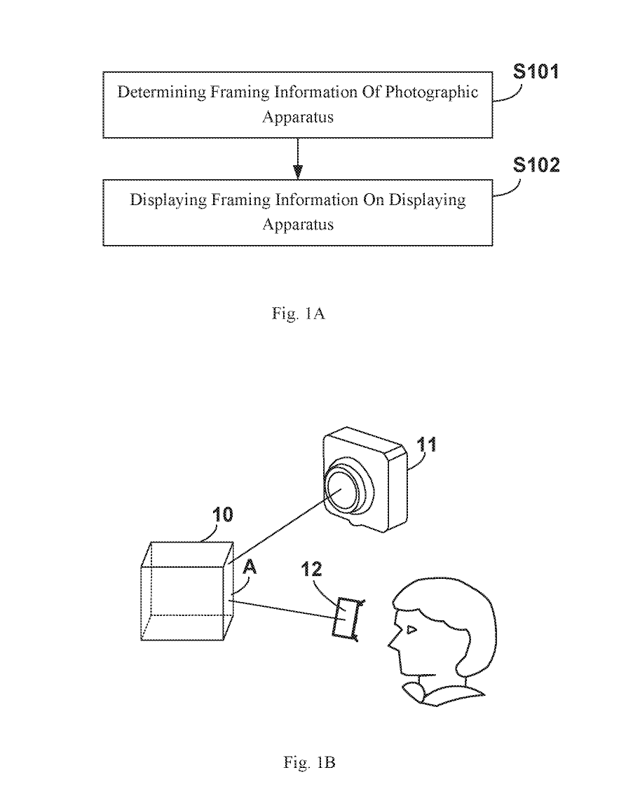

FIG. 1A is a flow chart showing a method for displaying framing information according to an exemplary embodiment. FIG. 1B is a schematic diagram of an applicable scene according to an embodiment of the present disclosure. The method for displaying framing information may be applied in an apparatus with a display function, such as smart glasses, eyeglasses. Referring to FIG. 1A, the method for displaying framing information includes steps S101 and S102.

In step S101, the framing information of a photographic apparatus is determined.

In exemplary embodiments, the framing information is information indicative of the extent of a view area, or view coverage, captured or capturable by the photographic apparatus, and shows the area or coverage that can be included in an image when a picture is taken by the photographic apparatus. For example, the framing information can include data representing a view shown in a viewfinder of the photographic apparatus. In one embodiment, the framing information of the photographic apparatus may be acquired by the viewfinder of the photographic apparatus. In one embodiment, the framing information may be transmitted to a displaying apparatus via wireless or wire transmission. The wireless transmission includes WIFI, Bluetooth, etc., and the wire transmission includes USB, etc. The specific manner of determining and transmitting the framing information of the photographic apparatus is not limited in the present disclosure.

In step S102, the framing information is displayed on the displaying apparatus.

In one embodiment, the framing information may be displayed on the displaying apparatus in a manner of parallel light beam. In another embodiment, the framing information may also be displayed on the displaying apparatus in a frame manner.

The embodiment shown in FIG. 1A is described below with reference to FIG. 1B. A cube 10 is disposed at one place, and a photographic apparatus 11 and a user are located at a side A of the cube 10. When the photographic apparatus 11 is prepared to take a photo of the cube 10, if the photographic apparatus 11 is currently located at a position higher than the location of the user, the user cannot directly view framing information of the photographic apparatus 11 from a display screen of the photographic apparatus 11. In this case, current framing information of the photographic apparatus 11 may be displayed on a displaying apparatus 12 by the method of the present disclosure, such that the user may view the current framing information of the photographic apparatus 11 via the displaying apparatus 12.

In this embodiment, by displaying the framing information of the photographic apparatus on the displaying apparatus, the user may directly view a framing range of the photographic apparatus via the displaying apparatus, such that a separation of the photographic apparatus and a framing display is realized. For the user, it simplifies an operation for adjusting the framing range of the digital camera.

In an embodiment, displaying the framing information on the displaying apparatus may include: converting the framing information into a parallel light beam, a boundary of the parallel light beam being determined by the framing information; and projecting the parallel light beam onto the displaying apparatus.

In an embodiment, the displaying apparatus may be smart glasses, and displaying the framing information on the displaying apparatus may include: determining a framing view corresponding to the framing information; determining a percentage of overlap between the framing view and an image view collected by a photographic device of the smart glasses in the image view; and displaying the framing information on a lens of the smart glasses according to the percentage of the view repeated.

In an embodiment, displaying the framing information on a lens of the smart glasses according to the percentage of overlap may include: displaying the framing information on the lens of the smart glasses in a full frame manner, if the percentage of overlap is greater than a first predetermined threshold; and displaying the framing information on the lens of the smart glasses in a partial frame manner, if the percentage of overlap is less than the first predetermined threshold and greater than a second predetermined threshold.

In an embodiment, the method may further include: displaying a prompt message for guiding a user to adjust a view direction, if the percentage of overlap is less than the second predetermined threshold.

In an embodiment, the displaying apparatus may be smart glasses, and displaying the framing information on the displaying apparatus may include: determining a framing view corresponding to the framing information; determining a similarity value between a main subject in the framing view and a main subject in an image view collected by a photographic device of the smart glasses; and displaying the framing information on a lens of the smart glasses according to the similarity value.

In an embodiment, displaying the framing information on a lens of the smart glasses according to the similarity value may include: displaying the framing information on the lens of the smart glasses in a full frame manner, if the similarity value is greater than a third predetermined threshold; and displaying the framing information on the lens of the smart glasses in a partial frame manner, if the similarity value is less than the third predetermined threshold and greater than a fourth predetermined threshold.

In an embodiment, the method may further include: displaying a prompt message for guiding a user to adjust a view direction, if the similarity value is less than the fourth predetermined threshold.

Concerning details about how to display the framing information of the photographic apparatus, reference is made to the following embodiments.

With the above method provided in the present disclosure, the separation of the photographic apparatus and the framing displaying is realized, and for the user, it simplifies the operation for adjusting the framing range of the digital camera.

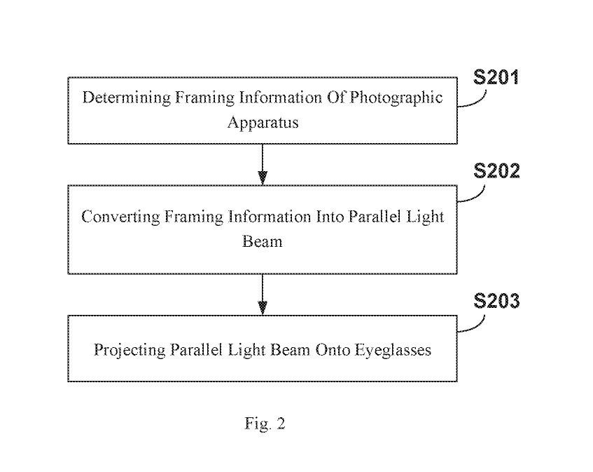

FIG. 2 is a flow chart showing the method for displaying framing information according to a first exemplary embodiment. This embodiment takes eyeglasses as the displaying apparatus for example to make an exemplary description. As shown in FIG. 2, the method includes following steps.

In step S201, framing information of a photographic apparatus is determined, similar to step S101 (FIG. 1A).

In step S202, the framing information is converted into a parallel light beam, and a boundary of the parallel light beam is determined based on the framing information.

In an embodiment, the framing information may be converted into the parallel light beam via an electronic-to-optical transducer, such as a laser device, a projector, etc.

In step S203, the parallel light beam is projected onto eyeglasses.

In the illustrated embodiment, by mounting a micro projecting device on the eyeglasses, the framing information of the photographic apparatus is projected onto a lens of the eyeglasses, so as to achieve a perspective effect for the lens.

In this embodiment, by projecting the framing information of the photographic apparatus onto the eyeglasses in a manner of parallel light beam, the separation of the photographic apparatus and the framing displaying is realized. Moreover, because a boundary of the framing information is projected onto the eyeglasses, the user may view the current framing range of the photographic apparatus by the eyeglasses, and simultaneously a true scene before the user by the eyeglasses, such that an actual visual field of the user will not be affected.

It may be understood by those skilled in the art that, in above embodiments of the present disclosure, the parallel light beam may also be projected onto the displaying apparatus via a projector by converting the framing information into the parallel light beam.

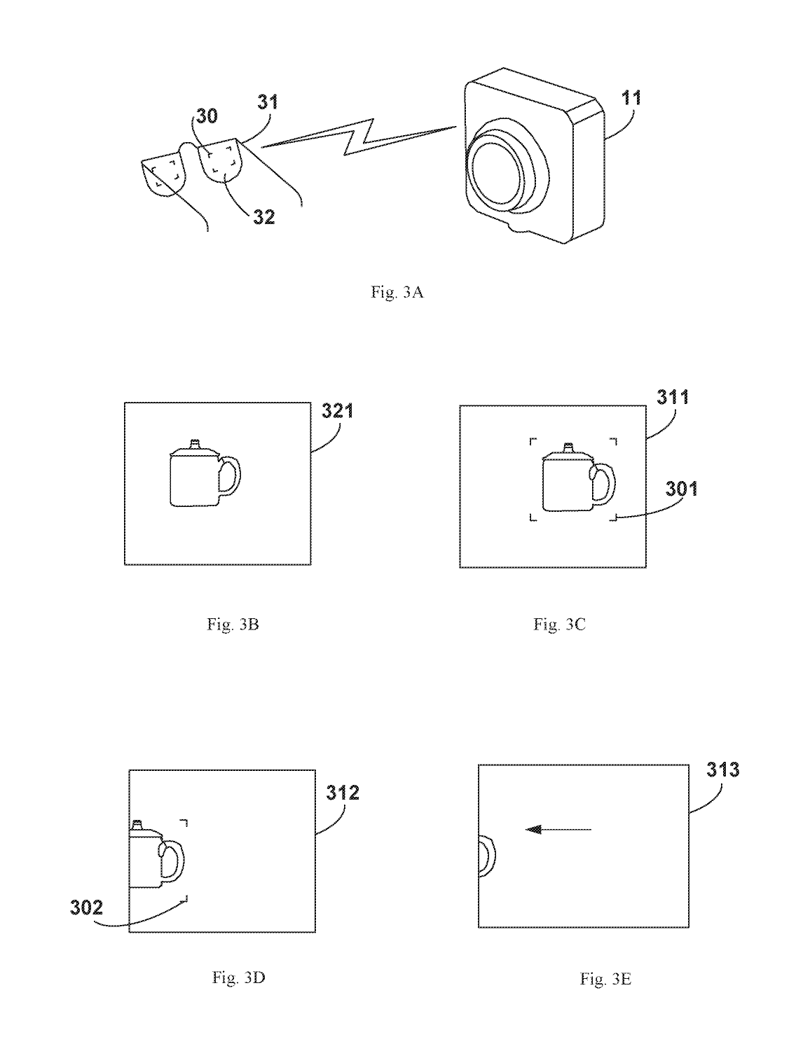

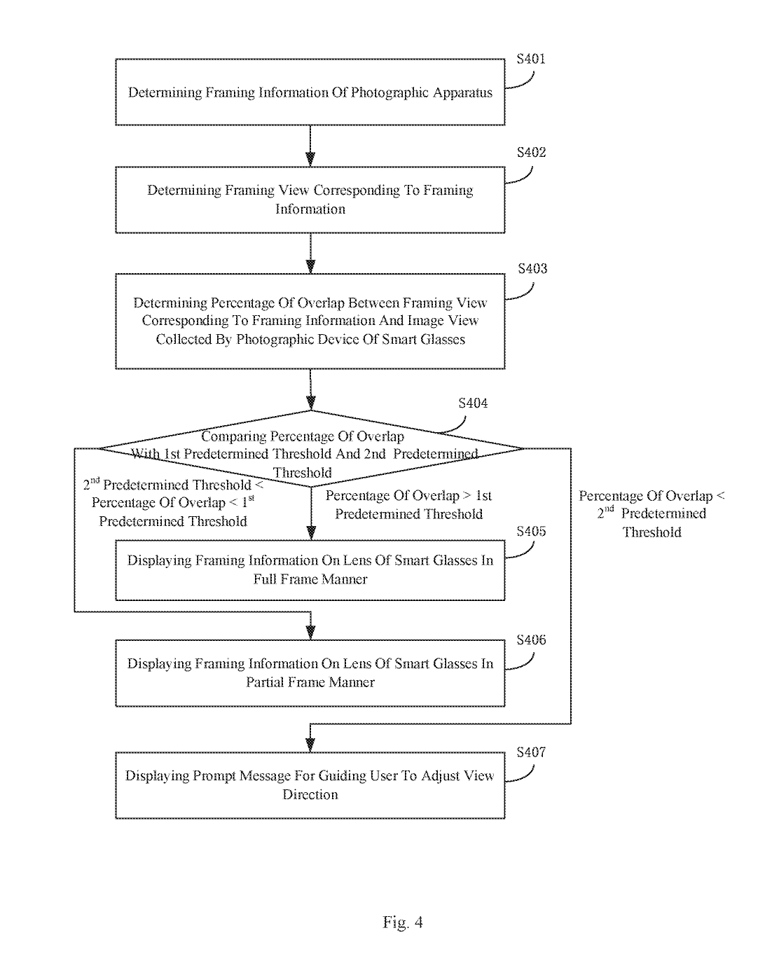

FIG. 3A is a schematic diagram of a system formed by a pair of smart glasses and a photographic apparatus and applicable to embodiments of the present disclosure. FIG. 3B is a schematic diagram of a framing view corresponding to framing information of the photographic apparatus according to an exemplary embodiment of the present disclosure. FIG. 3C is a first schematic diagram of an image view taken by the smart glasses according to an exemplary embodiment of the present disclosure. FIG. 3D is a second schematic diagram of an image view taken by the smart glasses according to an exemplary embodiment of the present disclosure. FIG. 3E is a third schematic diagram of an image view taken by the smart glasses according to an exemplary embodiment of the present disclosure.

As shown in FIG. 3A, smart glasses 31 and a photographic apparatus 11 may communicate in a wireless manner such as WIFI or infrared. In this way, the photographic apparatus 11 may transmit framing information to the smart glasses 31. The photographic apparatus 11 may determine the framing information of a lens of the photographic apparatus 11 via a viewfinder disposed on the photographic apparatus 11, and transmits the framing information determined by the viewfinder to the smart glasses 31. The smart glasses 31 display the framing information of the photographic apparatus 11 on a lens 32 of the smart glasses 31 in a frame 30. In an embodiment, the photographic apparatus 11 may be a device capable of collecting digital images, such as a digital camera, a sports camera, an SLR (Single Lens Reflex) camera.

FIG. 3B illustrates a current framing view 321 of the photographic apparatus 11. The viewfinder of the photographic apparatus 11 determines the framing information via the current framing view 321. FIG. 3C illustrates an image view 311 collected by a photographic device of the smart glasses 31 from an angle of the smart glasses 31 being worn by the user. FIG. 3D illustrates an image view 312 collected by the photographic device of the smart glasses 31 from another angle of the smart glasses 31 being worn by the user. FIG. 3E illustrates an image view 313 collected by the photographic device of the smart glasses 31 from yet another angle of the smart glasses 31 being worn by the user.

For example, as shown in FIGS. 3B and 3C, a cup appears in both the current framing view 321 of the photographic apparatus 11 and the image view 311 currently taken by the smart glasses 31, and the cup appears in respective views in essentially the same angle. In this case, it is determined that the current framing view 321 is essentially consistent with a visual direction of the user, and thus the framing information of the photographic apparatus 11 may be displayed on the lens 32 of the smart glasses 31 as a full frame 301, i.e., in a full frame manner. When the user wears the smart glasses 31, the user may obtain the current framing range of the photographic apparatus 11 via the full frame 301.

In another exemplary scene, as shown in FIG. 3D, the image view 312 is collected by the photographic device of the smart glasses 31 from another angle while the user wears the smart glasses 31. It is seen from contents of the framing view 321 of the photographic apparatus 11 and the image view 312 that, a part of the cup in the image view 312 is beyond a visual range of the smart glasses 31, indicating that there is a deviation between a view direction of the smart glasses 31 and a current photographing direction of the photographic apparatus 11. The framing view of the photographic apparatus 11 may be displayed on the lens 32 as a partial frame 302, i.e., in a partial frame manner, so as to remind the user to slightly adjust his or her visual direction, i.e., the view direction of the smart glasses 31. When it is detected that the current photographing direction of the photographic apparatus 11 is essentially consistent with the visual direction of the user, the framing information is displayed on the lens 32 as the full frame 301.

In yet another exemplary scene, as shown in FIG. 3E, the image view 313 is collected by the photographic device of the smart glasses 31 from yet another angle while the user wears the smart glasses 31. It is seen from contents of the framing view 321 of the photographic apparatus 11 and the image view 313 that, the cup in the image view 313 is beyond the current visual range of the user on the whole, indicating that there is a large deviation between the view direction of the smart glasses 31 and the current photographing direction of the photographic apparatus 11. In this case, prompt information for guiding the user to adjust his or her visual direction may be displayed on the lens 32 to guide the user to adjust his or her visual direction, until it is detected that the current photographing direction of the photographic apparatus 11 is essentially consistent with the visual direction of the user, and then the framing information is displayed on the lens 32 as the full frame 301.

In a situation where the visual range of the photographic apparatus cannot be directly viewed by the viewfinder of the photographic apparatus (for example, the photographic apparatus is a sports camera and the user has to take photos by fixing the sports camera on his or her head or along a floor), by displaying the framing information of the photographic apparatus on the displaying apparatus, the present embodiment may allow the user to directly view the framing range of the photographic apparatus via the displaying apparatus, so as to realize the separation of the photographic apparatus and the framing displaying. For the user, it simplifies the operation for adjusting the framing range of the digital camera. If the displaying apparatus is smart glasses, because the image currently collected by the photographic apparatus is not presented on the lens of the smart glasses, an actual visual field of the user will not be affected, such that while viewing the current framing range of the photographic apparatus via the smart glasses, the user may also view a true scene before his or her eyes, thus promoting an experience of the user for using the smart glasses.

FIG. 4 is a flow chart showing a method for displaying framing information according to a second exemplary embodiment. The method of this embodiment displays the framing information of a photographic apparatus on a lens of smart glasses according to a percentage of overlap between a framing view of the photographic apparatus corresponding to the framing information and an image view collected by a photographic device of the smart glasses. As shown in FIG. 4, the method includes following steps.

In step S401, the framing information of the photographic apparatus is determined, similar to step S101 (FIG. 1A).

In step S402, the framing view corresponding to the framing information is determined.

In an embodiment, the framing view may be transmitted to the smart glasses in a manner as the same as step S401.

In step S403, the percentage of overlapping between the framing view and the image view collected by the photographic device of the smart glasses is determined.

In an embodiment, the percentage of overlap is determined by analyzing a similarity and/or a consistency of a corresponding relationship of gray information of the framing view corresponding to the framing information and the image view collected by the photographic device of the smart glasses. For example, a degree of overlap between the image view collected by the photographic device of the smart glasses and the framing view collected by the photographic apparatus is determined by using the image view collected by the photographic device of the smart glasses as a reference. For example, if the resolution of the image view collected by the photographic device of the smart glasses is 640×480, and the number of pixels in the range of overlap between the image view collected by the photographic device of the smart glasses and the image view collected by the photographic apparatus is 320×150, then it may be determined that the percentage of overlap therebetween is (320×150)/(640×480)=0.156.

In step S404, the percentage of overlap is compared with a first predetermined threshold and a second predetermined threshold, with the second predetermined threshold being less than the first predetermined threshold. Then, the framing information is displayed on the lens of the smart glasses according to the comparison result. For example, if the percentage of overlap is greater than the first predetermined threshold, step S405 is executed; if the percentage of overlap is less than the first predetermined threshold and greater than the second predetermined threshold, step S406 is executed; and if the percentage of overlap is less than the second predetermined threshold, step S407 is executed.

In an embodiment, the first predetermined threshold and the second predetermined threshold may be determined according to resolutions of the photographic apparatus and the photographic device of the smart glasses, thus ensuring a calculation accuracy of the percentage of overlap.

In step S405, if the percentage of overlap is greater than the first predetermined threshold, the framing information is displayed on the lens of the smart glasses in a full frame manner.

As shown in FIG. 3C, the cup appears in the image view 311 currently taken by the smart glasses 31. Therefore, if it is determined that both the framing view and the image view contain a scene of the cup, and the percentage of overlap between the framing view and the image view is greater than the first predetermined threshold, it is determined that the cup appears in respective views in essentially the same angle. In this case, it may be determined that the framing view is consistent with the image view. As a result, the framing information may be displayed on the lens 32 of the smart glasses 31 as the full frame 301, i.e., in a full frame manner. That is, after the user wears the smart glasses 31, the current framing range of the photographic apparatus 11 may be obtained by the full frame 301. In an embodiment, the full frame 301 may be displayed on the lens 32 in color. For example, when the framing view is essentially consistent with the image view, the framing information is presented on the lens 32 as a green frame.

In step S406, if the percentage of overlap is less than the first predetermined threshold and greater than the second predetermined threshold, the framing information is displayed on the lens of the smart glasses in a partial frame manner.

As shown in FIG. 3D, the image view 312 is collected by the photographic device of the smart glasses 31 from another angle while the user wears the smart glasses 31. It is determined from contents of the framing view 321 of the photographic apparatus 11 and the image view 312 that the percentage of overlap between the framing view 321 taken by the photographic apparatus 11 and the image view 312 will be reduced. For example, when the percentage of overlap is less than the first predetermined threshold and greater than the second predetermined threshold, it is determined that there is a deviation between the view direction of the smart glasses 31 and the current photographing direction of the photographic apparatus 11. As a result, a red partial frame 302 may be displayed on the lens 32, so as to prompt the user to slightly adjust his or her visual direction, i.e., the view direction of the smart glasses 31. When it is detected that the framing information is essentially consistent with the image view currently collected by the photographic device of the smart glasses 31, i.e., the image view recollected by the photographic device of the smart glasses 31 after the adjustment of the view direction of the smart glasses 31, the framing information is displayed on the lens 32 as the full frame 301.

In step S407, if the percentage of overlap is less than the second predetermined threshold, a prompt message for guiding the user to adjust the view direction is displayed on the lens.

As shown in FIG. 3E, the image view 313 is collected by the photographic device of the smart glasses 31 from yet another angle while the user wears the smart glasses 31. It is determined from contents of the framing view 321 of the photographic apparatus 11 and the image view 313 that the percentage of overlap between the framing view 321 taken by the photographic apparatus 11 and the image view 313 in the image view will be reduced. For example, when the percentage of overlap is less than the second predetermined threshold, it is determined that the cup in the image view 313 is generally beyond the visual range of the smart glasses 31, and there is a large deviation between the view direction of the smart glasses 31 and the current photographing direction of the photographic apparatus 11. As a result, a prompt may be displayed on the lens 32 for indicating the direction in which the user needs to move, so as to guide the user to adjust the view direction until it is detected that the framing information is essentially consistent with the image view currently collected by the photographic device of the smart glasses 31. Then, the framing information is displayed on the lens 32 as the full frame 301. For example, by prompting the user via an arrow to adjust his or her current visual range, the current visual range of the photographic apparatus 11 may be obtained by the user.

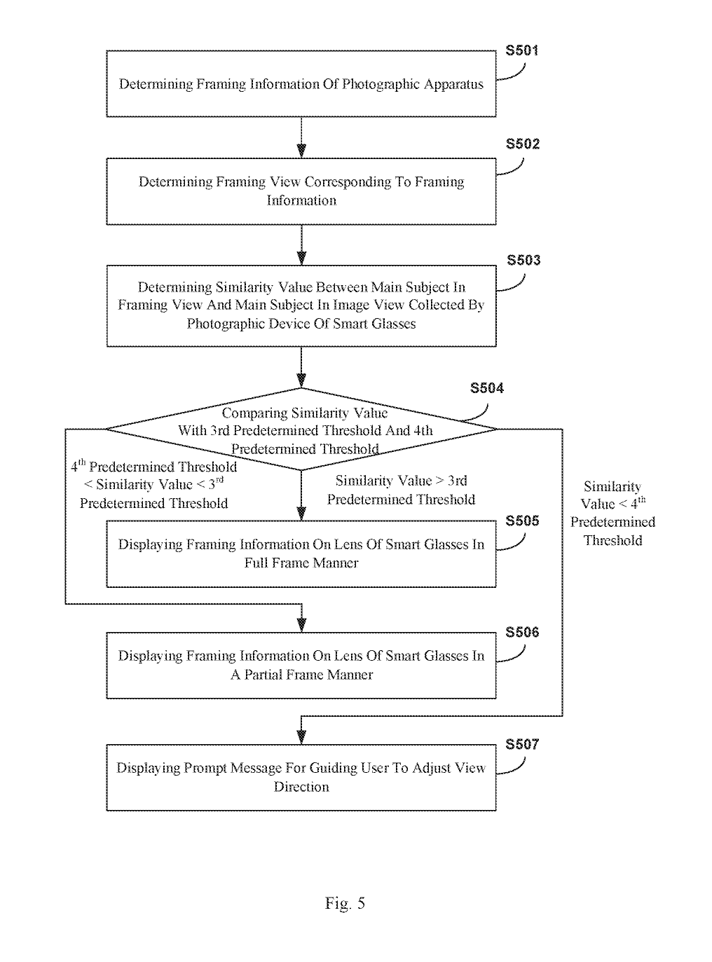

FIG. 5 is a flow chart showing a method for displaying framing information according to a third exemplary embodiment. The method of this embodiment displays the framing information of a photographic apparatus on a lens of smart glasses according to a similarity value between a main subject in the framing view corresponding to the framing information and a main subject in an image view collected by a photographic device of the smart glasses. As shown in FIG. 5, the method includes following steps.

In step S501, the framing information of the photographic apparatus is determined, similar to step S101 (FIG. 1A).

In step S502, the framing view corresponding to the framing information is determined, similar to step S402 (FIG. 4).

In step S503, a similarity value between the main subject in the framing view and the main subject in the image view collected by the photographic device of the smart glasses is determined.

In an embodiment, the similarity value is determined by analyzing a similarity of a corresponding relationship of a view content (i.e., the main subject in this embodiment) of the framing view collected by the photographic apparatus and a view content of the image view collected by the photographic device of the smart glasses.

In step S504, the similarity value is compared with a third predetermined threshold and a fourth predetermined threshold, with the fourth predetermined threshold being less than the third predetermined threshold. For example, if the similarity value is greater than the third predetermined threshold, step S505 is executed; if the similarity value is less than the third predetermined threshold and greater than the fourth predetermined threshold, step S506 is executed; and if the similarity value is less than the fourth predetermined threshold, step S507 is executed.

In an embodiment, the third predetermined threshold and the fourth predetermined threshold may be determined according to resolutions of the photographic apparatus and the photographic device of the smart glasses, thus ensuring a calculation accuracy of the percentage of the view repeated.

In step S505, if the similarity value is greater than the third predetermined threshold, the framing information is displayed on the lens of the smart glasses in a full frame manner.

As shown in FIGS. 3B-3C, the cup appears in both the current framing view 321 of the photographic apparatus 11 and the image view 311 currently taken by the smart glasses 31. If it is determined by an image detection technology that the similarity value therebetween is greater than the third predetermined threshold, it is determined that the cup appears in respective views in essentially the same angle. In this case, it may be determined that the view direction of the framing view 321 is consistent with that of the image view 311. As a result, the framing information of the photographic apparatus 11 may be displayed on the lens 32 of the smart glasses 31 as the full frame 301, i.e., in a full frame manner. That is, after the user wears the smart glasses 31, the current framing range of the photographic apparatus 11 may be obtained by the full frame 301. In an embodiment, the full frame 301 may be displayed on the lens 32 in color. For example, when the photographing direction of the framing view 321 is essentially consistent with the view direction of the image view 311, the full frame 301 is presented on the lens 32 as a green frame.

In step S506, if the similarity value is less than the third predetermined threshold and greater than the fourth predetermined threshold, the framing information is displayed on the lens of the smart glasses in a partial frame manner.

As shown in FIG. 3D, the image view 312 is collected by the photographic device of the smart glasses 31 from another angle while the user wears the smart glasses 31. It is determined from contents of the framing view 321 of the photographic apparatus 11 and the image view 312 that the similarity value between the cup in the framing view 321 taken by the photographic apparatus 11 and the cup in the image view 312 will be reduced. For example, when the similarity value is less than the third predetermined threshold and greater than the fourth predetermined threshold, it is determined that there is a deviation between the view direction of the smart glasses 31 and the current photographing direction of the photographic apparatus 11. As a result, the framing information may be displayed on the lens 32 as a partial frame 302, i.e., in a partial frame manner and, particularly, as a red frame, so as to prompt the user to slightly adjust his or her visual direction, i.e., the view direction of the smart glasses 31. When it is detected that the framing information is essentially consistent with the image view currently collected by the photographic device of the smart glasses 31, the framing information is displayed on the lens 32 in a full frame manner.

In step S507, if the similarity value is less than the fourth predetermined threshold, a prompt message for guiding the user to adjust the view direction is displayed on the lens.

As shown in FIG. 3E, the image view 313 is collected by the photographic device of the smart glasses 31 from yet another angle while the user wears the smart glasses 31. It is determined from contents of the framing view 321 of the photographic apparatus 11 and the image view 313 the similarity value between the cup in the framing view 321 taken by the photographic apparatus 11 and the cup in the image view 313 will be reduced. For example, when the similarity value is less than the fourth predetermined threshold, it is determined that the cup in the image view 313 is generally beyond the visual range of the smart glasses 31, and there is a deviation between the smart glasses 31 and the current photographing direction of the photographic apparatus 11. As a result, a prompt may be displayed on the lens 32 for indicating the direction in which the user needs to move, so as to guide the user to adjust his or her visual direction until it is detected that the framing information is essentially consistent with the image view currently collected by the photographic device of the smart glasses 31. Then, the framing information is displayed on the lens 32 in the full frame manner. For example, by prompting the user via an arrow to adjust his or her current visual range, the current visual range of the photographic apparatus 11 may be obtained by the user.

It may be understood by those skilled in the art that, the percentage of overlap and the similarly between the main subjects are taken as exemplary examples for illustration. The consistency of the visual range between the framing view and the image view may also be determined according to information such as image characteristics of the framing view and the image view and a texture characteristic of the image view. The exemplary illustration of the percentage of overlap and the similarity between the main subjects described above do not restrict the present disclosure.

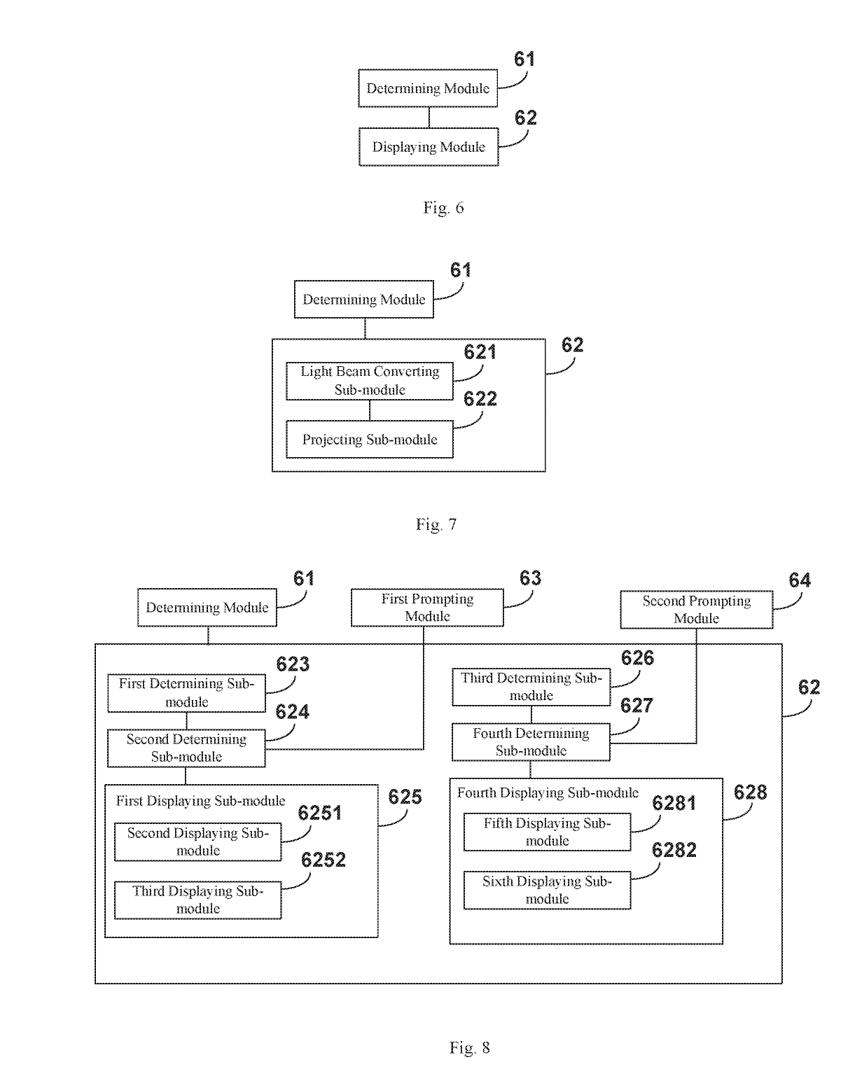

FIG. 6 is a block diagram of an apparatus for displaying framing information according to an exemplary embodiment. As shown in FIG. 6, the apparatus for displaying framing information includes: a determining module 61 configured to determine framing information of a photographic apparatus; and a displaying module 62 configured to display the framing information determined by the determining module 61 on a displaying apparatus.

FIG. 7 is a block diagram of another apparatus for displaying framing information according to an exemplary embodiment. The embodiment illustrated in FIG. 7 is based on the embodiment illustrated in FIG. 6. In the embodiment illustrated in FIG. 7, the displaying module 62 may include: a light beam converting sub-module 621 configured to convert the framing information determined by the determining module 61 into a parallel light beam, a boundary of the parallel light beam being determined by the framing information; and a projecting sub-module 622 configured to project the parallel light beam converted by the light beam converting sub-module 621 onto the displaying apparatus.

FIG. 8 is a block diagram of yet another apparatus for displaying framing information according to an exemplary embodiment. The embodiment illustrated in FIG. 8 is based on the embodiment illustrated in FIG. 6 or FIG. 7. In the embodiment illustrated in FIG. 8, the display apparatus is a pair of smart glasses, and the displaying module 62 may include: a first determining sub-module 623 configured to determine a framing view corresponding to the framing information determined by the determining module 61; a second determining sub-module 624 configured to determine a percentage of overlap between the framing view determined by first determining sub-module 623 and an image view collected by a photographic device of the smart glasses; and a first displaying sub-module 625 configured to display the framing information on a lens of the smart glasses according to the percentage of overlap determined by the second determining sub-module 624.

In an embodiment, the first displaying sub-module 625 may include: a second displaying sub-module 6251 configured to display the framing information on the lens of the smart glasses in a full frame manner, if the percentage of overlap determined by the second determining sub-module 624 is greater than a first predetermined threshold; a third displaying sub-module 6252 configured to display the framing information on the lens of the smart glasses in a partial frame manner, if the percentage of overlap determined by the second determining sub-module 624 is less than the first predetermined threshold and greater than a second predetermined threshold.

In an embodiment, the apparatus may further include: a first prompting module 63 configured to display a prompt message for guiding a user to adjust a view direction on the lens, if the percentage of overlap determined by the second determining sub-module 624 is less than the second predetermined threshold.

In an embodiment, the displaying module 62 may include: a third determining sub-module 626 configured to determine a framing view corresponding to the framing information determined by the determining module 61; a fourth determining sub-module 627 configured to determine a similarity value between a main subject in the framing view determined by the third determining sub-module 626 and a main subject in an image view collected by a photographic device of the smart glasses; a fourth displaying sub-module 628 configured to display the framing information on a lens of the smart glasses according to the similarity value determined by the fourth determining sub-module 627.

In an embodiment, the fourth displaying sub-module 628 may include: a fifth displaying sub-module 6281 configured to display the framing information on the lens of the smart glasses in a full frame manner, if the similarity value determined by the fourth determining sub-module 627 is greater than a third predetermined threshold; and a sixth displaying sub-module 6282 configured to display the framing information on the lens of the smart glasses in a partial frame manner, if the similarity value determined by the fourth determining sub-module 627 is less than the third predetermined threshold and greater than a fourth predetermined threshold.

In an embodiment, the apparatus may further include: a second prompting module 64 configured to display a prompt message for guiding a user to adjust a view direction on the lens, if the similarity value determined by the fourth determining sub-module 627 is less than the four predetermined threshold.

With respect to the apparatus in the above embodiments, the specific manners for performing operations for individual modules therein have been described in detail in the embodiments regarding the methods, which will not be elaborated herein.

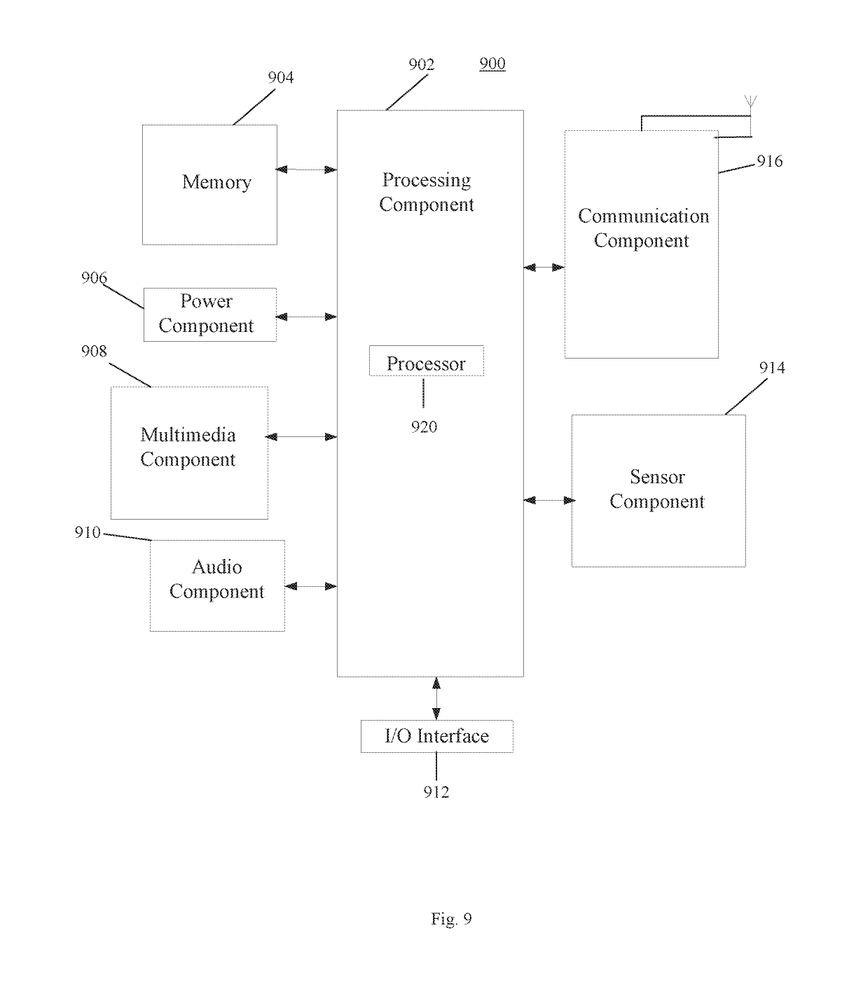

FIG. 9 is a block diagram of a device 900 for displaying framing information according to an exemplary embodiment. For example, the device 900 may be smart glasses, a mobile phone, a computer, a digital broadcast terminal, a messaging device, a gaming console, a tablet, a medical device, exercise equipment, a personal digital assistant, and the like.

Referring to FIG. 9, the device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a screen providing an output interface between the device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia datum while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone configured to receive an external audio signal when the device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the device 900 and other devices. The device 900 can access a wireless network based on a communication standard, such as WiFi, 2G, or 3G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 904, executable by the processor 920 in the device 900, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above-described modules can each be implemented by hardware, or software, or a combination of hardware and software. One of ordinary skill in the art will also understand that multiple ones of the above-described modules may be combined as one module, and each of the above-described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for displaying framing information on a displaying apparatus, comprising:
determining framing information of a photographic apparatus; and
displaying the framing information on the displaying apparatus.

2. The method according to claim 1, wherein displaying the framing information on the displaying apparatus comprises:
converting the framing information into a parallel light beam, a boundary of the parallel light beam being determined by the framing information; and
projecting the parallel light beam onto the displaying apparatus.

3. The method according to claim 1, wherein the displaying apparatus is smart glasses, and displaying the framing information on the displaying apparatus comprises:
determining a framing view corresponding to the framing information;
determining a percentage of overlap between the framing view and an image view collected by a photographic device of the smart glasses; and
displaying the framing information on a lens of the smart glasses according to the percentage of overlap.

4. The method according to claim 3, wherein displaying the framing information on a lens of the smart glasses according to the percentage of overlap comprises:
displaying the framing information on the lens of the smart glasses in a full frame manner, if the percentage of overlap is greater than a first predetermined threshold; and
displaying the framing information on the lens of the smart glasses in a partial frame manner, if the percentage of overlap is less than the first predetermined threshold and greater than a second predetermined threshold.

5. The method according to claim 4, further comprising:
displaying a prompt message for guiding a user to adjust a view direction, if the percentage of overlap is less than the second predetermined threshold.

6. The method according to claim 1, wherein the displaying apparatus is smart glasses, and displaying the framing information on the displaying apparatus comprises:
determining a framing view corresponding to the framing information;
determining a similarity value between a main subject in the framing view and a main subject in an image view collected by a photographic device of the smart glasses; and
displaying the framing information on a lens of the smart glasses according to the similarity value.

7. The method according to claim 6, wherein displaying the framing information on a lens of the smart glasses according to the similarity value comprises:
displaying the framing information on the lens of the smart glasses in a full frame manner, if the similarity value is greater than a third predetermined threshold; and
displaying the framing information on the lens of the smart glasses in a partial frame manner, if the similarity value is less than the third predetermined threshold and greater than a fourth predetermined threshold.

8. The method according to claim 7, further comprising:
displaying a prompt message for guiding a user to adjust a view direction, if the similarity value is less than the fourth predetermined threshold.

9. A displaying apparatus, comprising:
a processer;
a memory for storing instructions executable by the processor;
wherein the processer is configured to:
determine framing information of a photographic apparatus; and
display the framing information on the displaying apparatus.

10. The displaying apparatus according to claim 9, wherein the processer is configured to display the framing information by:
converting the framing information into a parallel light beam, a boundary of the parallel light beam being determined by the framing information; and
projecting the parallel light beam onto the displaying apparatus.

11. The displaying apparatus according to claim 9, wherein the displaying apparatus is smart glasses, and the processer is configured to display the framing information by:
determining a framing view corresponding to the framing information;
determining a percentage of overlap between the framing view and an image view collected by a photographic device of the smart glasses; and
displaying the framing information on a lens of the smart glasses according to the percentage of overlap.

12. The displaying apparatus according to claim 11, wherein the processer is configured to display the framing information on a lens of the smart glasses according to the percentage of overlap by:
displaying the framing information on the lens of the smart glasses in a full frame manner, if the percentage of overlap is greater than a first predetermined threshold; and
displaying the framing information on the lens of the smart glasses in a partial frame manner, if the percentage of overlap is less than the first predetermined threshold and greater than a second predetermined threshold.

13. The displaying apparatus according to claim 12, wherein the processer is further configured to:
display a prompt message for guiding a user to adjust a view direction, if the percentage of overlap is less than the second predetermined threshold.

14. The displaying apparatus according to claim 9, wherein the displaying apparatus is smart glasses, and the processer is configured to display the framing information by:
determining a framing view corresponding to the framing information;
determining a similarity value between a main subject in the framing view and a main subject in an image view collected by a photographic device of the smart glasses; and
displaying the framing information on a lens of the smart glasses according to the similarity value.

15. The displaying apparatus according to claim 14, wherein the processer is configured to display the framing information on a lens of the smart glasses according to the similarity value by:
displaying the framing information on the lens of the smart glasses in a full frame manner, if the similarity value is greater than a third predetermined threshold; and
displaying the framing information on the lens of the smart glasses in a partial frame manner, if the similarity value is less than the third predetermined threshold and greater than a fourth predetermined threshold.

16. The displaying apparatus according to claim 15, wherein the processer is further configured to:
display a prompt message for guiding a user to adjust a view direction, if the similarity value is less than the four predetermined threshold.

17. A non-transitory computer-readable storage medium having stored therein instructions that, when executed by a processor of a device, cause the device to perform a method for displaying framing information, the method comprising:
determining framing information of a photographic apparatus; and
displaying the framing information on a displaying apparatus.
